(19) United States
(12) Patent Application Publication
(10) Pub. No.: US 2022/0399171 A1
(43) Pub. Date: Dec. 15, 2022

(54) KEYBOARD DEVICE AND KEY STRUCTURE THEREOF

(71) Applicant: Primax Electronics Ltd., Taipei (TW)

(72) Inventors: Che-An Li, Taipei (TW); Lei-Lung Tsai, Taipei (TW); Sheng-Fan Chang, Taipei (TW)

(21) Appl. No.: 17/388,244

(22) Filed: Jul. 29, 2021

(30) Foreign Application Priority Data
Jun. 11, 2021 (TW) 110121346

(51) Int. Cl. H01H 13/7065; H01H 3/12

(52) U.S. Cl. CPC H01H 13/7065; H01H 3/125; H01H 2231/002

(57) ABSTRACT

A keyboard device includes plural key structures. Each key structure includes a keycap, a membrane circuit board, a key frame, an elastic conduction element and a connecting member. The membrane circuit board is located under the keycap. The key frame is arranged between the keycap and the membrane circuit board. The key frame includes a frame body and a bottom plate. The bottom plate is arranged between the key frame and the membrane circuit board. The bottom plate includes a perforation. The elastic conduction element is arranged between the keycap and the bottom plate of the key frame. The perforation is covered by the elastic conduction element. The connecting member is arranged between the keycap and the bottom plate of the key frame. The keycap is movable upwardly or downwardly relative to the bottom plate of the key frame through the connecting member.

### FIELD OF THE INVENTION

The present invention relates to an input device, and more particularly to a keyboard device and a key structure thereof.

### BACKGROUND OF THE INVENTION

With increasing development of science and technology, a variety of electronic devices are designed in views of convenience and user-friendliness. For helping the user well operate the electronic devices, the electronic devices are gradually developed in views of humanization. The input devices of the common electronic devices include for example mouse devices, keyboard devices, trackball devices, or the like. Via the keyboard device, texts or symbols can be inputted into the computer system directly. As a consequence, most users and most manufacturers of input devices pay much attention to the development of keyboard devices.

Generally, a keyboard device comprises plural key structures. Each key structure comprises a keycap, a scissors-type connecting member, a membrane circuit board and a base plate. These components are stacked on each other sequentially. In case that the keyboard device is a luminous keyboard device, the keyboard device is equipped with a backlight module under the base plate.

Moreover, a membrane switch is installed on the membrane circuit board, and an elastic element is arranged between the keycap and the membrane circuit board. The scissors-type connecting member is connected between the keycap and the base plate. Moreover, the scissors-type connecting member comprises a first frame and a second frame. The second frame is pivotally coupled to the first frame. Consequently, the first frame and the second frame can be swung relative to each other. While the keycap of any key structure is pressed down and moved downwardly relative to the base plate, the first frame and the second frame of the scissors-type connecting member are switched from an open-scissors state to a stacked state. Moreover, as the keycap is moved downwardly to compress the elastic element, the corresponding membrane switch is pushed and triggered by the elastic element. Consequently, the keyboard device generates a corresponding key signal.

When the keycap of the key structure is no longer pressed, the keycap is moved upwardly relative to the base plate in response to an elastic force of the elastic element. Meanwhile, the first frame and the second frame are switched from the stacked state to the open-scissors state, and the keycap is returned to its original position.

As mentioned above, each key structure of the conventional keyboard device comprises five main components, including the keycap, the scissors-type connecting member, the membrane circuit board, the base plate and the elastic element. In case that the backlight is required, the keyboard device is equipped with the backlight module under the base plate. Since the base plate is made of metallic material, the overall weight of the keyboard device is largely increased. Moreover, since the membrane circuit board is located over the base plate, it is necessary to form openings in the membrane circuit board at proper locations. As a consequence, the first frame and the second frame of the scissors-type connecting member can be penetrated through the openings and connected with the base plate. However, since the difficulty of the fabricating process is increased, the fabricating cost is increased.

Therefore, there is a need of providing an improved keyboard device in order to overcome the drawbacks of the conventional technologies.

### SUMMARY OF THE INVENTION

An object of the present invention provides a keyboard device. The overall weight of the keyboard device is reduced, and the structure of the keyboard device is simplified. The present invention also provides a key structure of the keyboard device.

The other objects and advantages of the present invention will be understood from the disclosed technical features.

In accordance with an aspect of the present invention, a keyboard device is provided. The keyboard device includes plural key structures. Each of the plural key structures includes a keycap, a membrane circuit board, a key frame, an elastic conduction element and a connecting member. The membrane circuit board is located under the keycap. The key frame is arranged between the keycap and the membrane circuit board. The key frame includes a frame body and a bottom plate. The bottom plate is arranged between the frame body and the membrane circuit board. The bottom plate includes a perforation. The elastic conduction element is arranged between the keycap and the bottom plate of the key frame. The perforation is covered by the elastic conduction element. The connecting member is arranged between the keycap and the bottom plate of the key frame. The keycap is movable upwardly or downwardly relative to the bottom plate of the key frame through the connecting member.

In an embodiment, the elastic conduction element includes a covering part and a conduction post. The covering part includes an accommodation space. The conduction post is connected with the covering part and disposed within the accommodation space.

In an embodiment, the covering part of the elastic conduction element includes a top wall, a ring-shaped lower part and a lateral wall. The top wall is connected with the keycap. The lateral wall is extended downwardly from a periphery region of the top wall and connected with the ring-shaped lower part. The ring-shaped lower part is contacted with the bottom plate of the key frame. The accommodation space is defined by the top wall and the lateral wall. The conduction post is connected with the top wall.

In an embodiment, while the keycap is moved downwardly relative to the bottom plate of the key frame through the connecting member, the covering part of the elastic conduction element is compressed by the keycap, the lateral wall is subjected to deformation, and the top wall is correspondingly moved downwardly. While the top wall is moved downwardly, the conduction post is moved downwardly in a direction toward the membrane circuit board. While the conduction post is moved downwardly, the conduction post is penetrated through the perforation of the bottom plate and contacted with a membrane switch of the membrane circuit board.

In an embodiment, the bottom plate of the key frame further includes a fixing recess. The fixing recess is arranged around the perforation. The ring-shaped lower part of the elastic conduction element is embedded in the fixing recess of the bottom plate.

In an embodiment, the bottom plate of the key frame further includes plural hollow portions, and the perforation is arranged between the plural hollow portions.

In an embodiment, the bottom plate of the key frame has a top surface and a bottom surface, which are opposed to each other. The connecting member is installed on the top surface of the bottom plate. The membrane circuit board is installed on the bottom surface of the bottom plate.

In an embodiment, the connecting member is a scissors-type connecting member.

In an embodiment, the key frame is made of plastic material.

In accordance with another aspect of the present invention, a key structure is provided. The key structure includes a keycap, a membrane circuit board, a key frame, an elastic conduction element and a connecting member. The membrane circuit board is located under the keycap. The key frame is arranged between the keycap and the membrane circuit board. The key frame includes a frame body and a bottom plate. The bottom plate is arranged between the frame body and the membrane circuit board. The bottom plate includes a perforation. The elastic conduction element is arranged between the keycap and the bottom plate of the key frame. The perforation is covered by the elastic conduction element. The connecting member is arranged between the keycap and the bottom plate of the key frame. The keycap is movable upwardly or downwardly relative to the bottom plate of the key frame through the connecting member.

From the above descriptions, the present invention provides the keyboard device. Each key structure of the keyboard device comprises the keycap, the membrane circuit board, the key frame, the elastic conduction element and the connecting member. The key frame made of the plastic material is used in the key structure of the present invention to replace the metallic base plate of the conventional key structure. Consequently, the overall weight of the keyboard device is largely reduced. Moreover, since the membrane circuit board is located under the key frame and the elastic conduction element and the connecting member are installed on the bottom plate of the key frame, it is not necessary to additionally form openings in the membrane circuit board for allowing the connecting member to pass through. Due to this structural design, the process of fabricating the keyboard device is effectively simplified, and the fabricating cost is largely reduced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a keyboard device according to an embodiment of the present invention;

FIG. 2 is a schematic perspective view illustrating a portion of a key structure of the keyboard device as shown in FIG. 1;

FIG. 3 is a schematic exploded view illustrating the key structure as shown in FIG. 2; and

FIG. 4 is a schematic cross-sectional view illustrating the key structure as shown in FIG. 2 and taken along the line AA.

### DETAILED DESCRIPTION OF THE PREFERRED EMBODIMENT

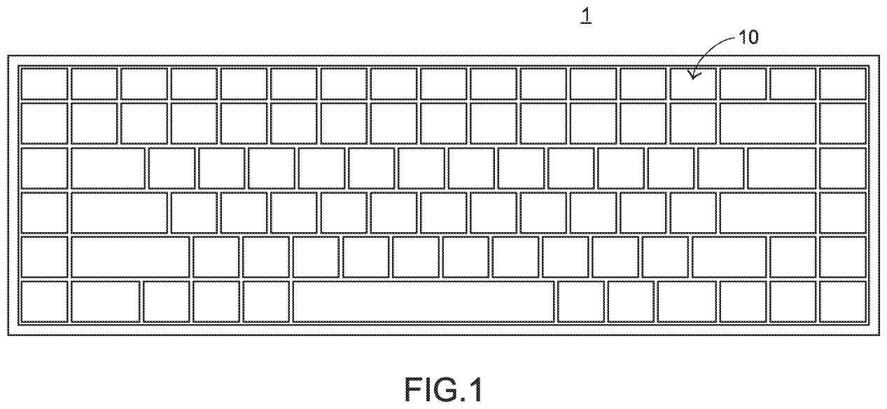

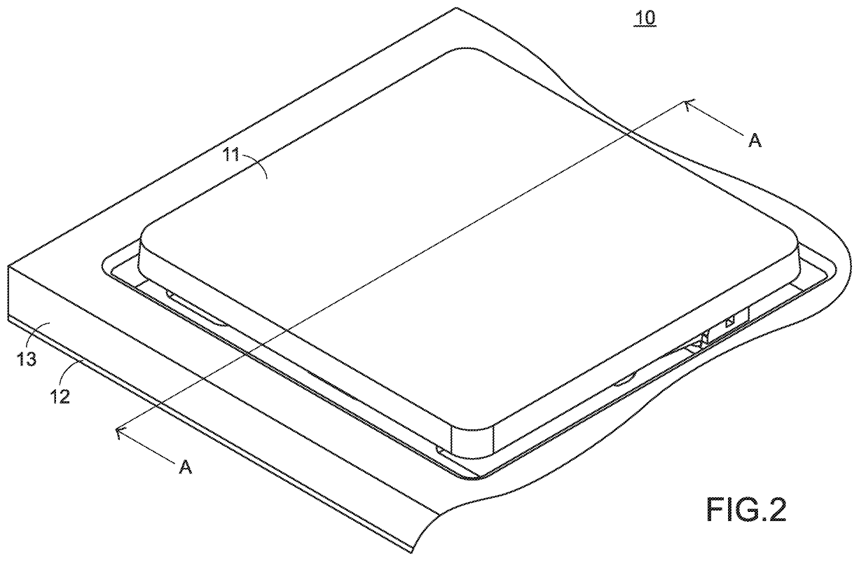

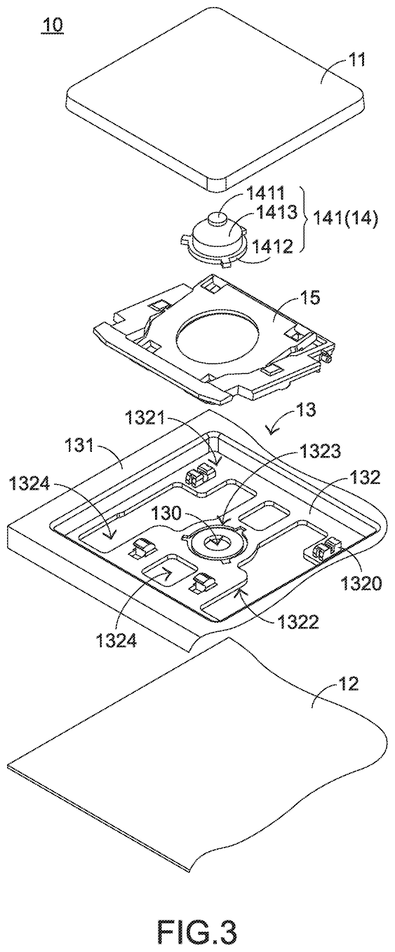

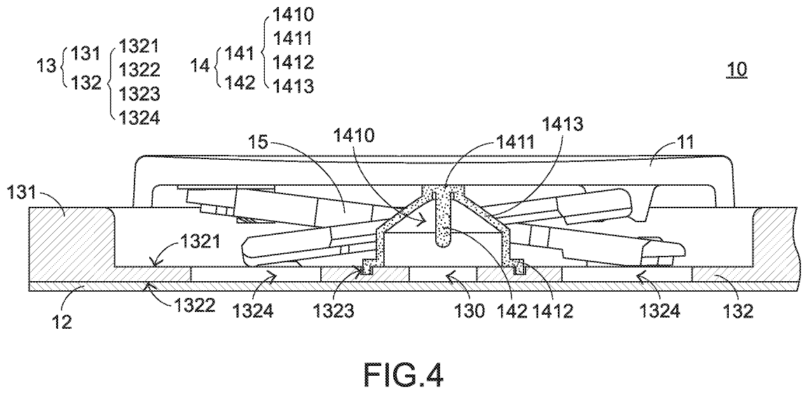

Please refer to FIGS. 1, 2, 3 and 4. FIG. 1 is a schematic top view illustrating the outer appearance of a keyboard device according to an embodiment of the present invention. FIG. 2 is a schematic perspective view illustrating a portion of a key structure of the keyboard device as shown in FIG. 1. FIG. 3 is a schematic exploded view illustrating the key structure as shown in FIG. 2. FIG. 4 is a schematic cross-sectional view illustrating the key structure as shown in FIG. 2 and taken along the line AA. For succinctness, only a single structure and associated components are shown in FIGS. 2, 3 and 4.

As shown in FIG. 1, the keyboard device 1 comprises plural key structures 10. These key structures 10 are classified into some types, e.g., ordinary keys, numeric keys and function keys. When one of the key structures 10 is depressed by the user's finger, the keyboard device 1 generates a corresponding key signal to a computer, and thus the computer executes a corresponding function. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

The key structure 10 of the keyboard device 1 will be described in more details as follows.

Please refer to FIGS. 2, 3 and 4 again. The key structure 10 comprises a keycap 11, a membrane circuit board 12, a key frame 13, an elastic conduction element 14 and a connecting member 15. The membrane circuit board 12 is located under the keycap 11. The key frame 13 is arranged between the keycap 11 and the membrane circuit board 12. The key frame 13 comprises a frame body 131 and a bottom plate 132. The bottom plate 132 of the key frame 13 is arranged between the frame body 131 and the membrane circuit board 12. The bottom plate 132 of the key frame 13 comprises a perforation 130. The elastic conduction element 14 is arranged between the keycap 11 and the bottom plate 132 of the key frame 13. The perforation 130 of the bottom plate 132 of the key frame 13 is covered by the elastic conduction element 14. The connecting member 15 is arranged between the keycap 11 and the bottom plate 132 of the key frame 13. The keycap 11 is movable upwardly or downwardly relative to the bottom plate 132 of the key frame 13 through the connecting member 15.

In this embodiment, the key frame 13 is made of plastic material. That is, the frame body 131 and the bottom plate 132 are integrated into a one-piece structure by a plastic molding process. It is noted that the material of the key frame 13 is not restricted. That is, the material of the key frame 13 may be varied according to the practical requirements. Since the key frame 13 is made of the plastic material, the weight of each key structure 10 is reduced. When compared with the conventional keyboard device with the metallic base plate, the overall weight of the keyboard device 1 of the present invention is largely reduced. Especially, the key frame 13 can be easily formed by developing a mold and performing a single injection molding process or a multi-injection molding process. Consequently, the fabricating cost of the keyboard device 1 is effectively reduced.

Please refer to FIGS. 2, 3 and 4 again. The bottom plate 132 of the key frame 13 has a top surface 1321 and a bottom surface 1322, which are opposed to each other. The connecting member 15 is installed on the top surface 1321 of the bottom plate 132. The membrane circuit board 12 is installed on the bottom surface 1322 of the bottom plate 132. In an embodiment, the connecting member 15 is a scissors-type connecting member. It is noted that the example of the connecting member 15 is not restricted. In this embodiment, plural hooks 1320 are installed on the top surface 1321 of the bottom plate 132. The connecting member 15 is connected with the bottom plate 132 of the key frame 13 through the hooks 1320. It is noted that the way of connecting the connecting member 15 with the bottom plate 132 of the key frame 13 is not restricted. That is, the connecting member 15 can be connected with the bottom plate 132 of the key frame 13 through any other appropriate coupling means. The actions of the connecting member 15 are similar to those of the conventional technologies, and not redundantly described herein.

As mentioned above, the membrane circuit board 12 and the connecting member 15 are installed on the bottom surface 1322 and the top surface 1321 of the bottom plate 132, respectively. Consequently, the connecting member 15 can be connected with the bottom plate 132 of the key frame 13 without the need of being penetrated through the membrane circuit board 12. In other words, it is not necessary to additionally form openings in the membrane circuit board 12 for allowing the connecting member 15 to pass through. Consequently, the process of fabricating the keyboard device 1 is effectively simplified.

Please refer to FIGS. 2, 3 and 4 again. In this embodiment, the elastic conduction element 14 comprises a covering part 141 and a conduction post 142. The covering part 141 comprises an accommodation space 1410. The conduction post 142 is connected with the covering part 141 and disposed within the accommodation space 1410. The covering part 141 of the elastic conduction element 14 comprises a top wall 1411, a ring-shaped lower part 1412 and a lateral wall 1413. The top wall 1411 of the covering part 141 of the elastic conduction element 14 is connected with the keycap 11. The lateral wall 1413 is extended downwardly from the periphery region of the top wall 1411 and connected with the ring-shaped lower part 1412. That is, the lateral wall 1413 is connected between the top wall 1411 and the ring-shaped lower part 1412. In addition, the ring-shaped lower part 1412 is contacted with the bottom plate 132 of the key frame 13. The accommodation space 1410 is defined by the top wall 1411 and the lateral wall 1414 of the covering part 141. In an embodiment, the conduction post 142 of the elastic conduction element 14 is connected with the top wall 1411.

While the keycap 11 is moved downwardly relative to the bottom plate 132 of the key frame 13 through the connecting member 15, the covering part 141 of the elastic conduction element 14 is compressed by the keycap 11, and the lateral wall 1413 is subjected to deformation. While the lateral wall 1413 is subjected to deformation, the top wall 1411 is correspondingly moved downwardly. While the top wall 1411 is moved downwardly, the conduction post 142 connected with the top wall 1411 is moved downwardly in the direction toward the membrane circuit board 12. While the conduction post 142 is moved downwardly, the conduction post 142 is penetrated through the perforation 130 of the bottom plate 132 and contacted with a membrane switch (not shown) on the membrane circuit board 12.

Please refer to FIGS. 3 and 4 again. In an embodiment, the bottom plate 132 of the key frame 13 further comprises a fixing recess 1323. The fixing recess 1323 of the bottom plate 132 is arranged around the perforation 130. In an embodiment, the ring-shaped lower part 1412 of the elastic conduction element 14 is embedded in the fixing recess 1323 of the bottom plate 13. Consequently, the elastic conduction element 14 can be fixed on the bottom plate 132 of the key frame 13. As mentioned above, the elastic conduction element 14 can be fixed on the bottom plate 132 through the fixing recess 1323. Moreover, after the elastic conduction element 14 is embedded in the fixing recess 1323, the conduction post 142 of the elastic conduction element 14 is aligned with the perforation 130 of the bottom plate 132. Consequently, while the conduction post 142 of the elastic conduction element 14 is moved downwardly, the conduction post 142 of the elastic conduction element 14 can be smoothly penetrated through the perforation 130 of the bottom plate 132 and contacted with the membrane switch on the membrane circuit board 12.

Please refer to FIGS. 3 and 4 again. In an embodiment, the bottom plate 132 of the key frame 13 further comprises plural hollow portions 1324. The perforation 130 of the bottom plate 132 is arranged between these hollow portions 1324. The arrangement of the hollow portions 1324 in the bottom plate 132 of the key frame 13 can further reduce the weight of the key frame 13. Consequently, the overall weight of the keyboard device 1 is further reduced. In this embodiment, the bottom plate 132 of the key frame 13 comprises four hollow portions 1324. It is noted that the number of the hollow portions 1324 is not restricted. That is, the number of the hollow portions 1324 may be increased or decreased according to the practical requirements.

From the above descriptions, the present invention provides the keyboard device. Each key structure of the keyboard device comprises the keycap, the membrane circuit board, the key frame, the elastic conduction element and the connecting member. The key frame made of the plastic material is used in the key structure of the present invention to replace the metallic base plate of the conventional key structure. Consequently, the overall weight of the keyboard device is largely reduced. Moreover, since the membrane circuit board is located under the key frame and the elastic conduction element and the connecting member are installed on the bottom plate of the key frame, it is not necessary to additionally form openings in the membrane circuit board for allowing the connecting member to pass through. Due to this structural design, the process of fabricating the keyboard device is effectively simplified, and the fabricating cost is largely reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A keyboard device comprising plural key structures, wherein each of the plural key structures comprises:
a keycap;
a membrane circuit board located under the keycap;
a key frame arranged between the keycap and the membrane circuit board, wherein the key frame comprises a frame body and a bottom plate, the bottom plate is arranged between the frame body and the membrane circuit board, and the bottom plate comprises a perforation;
an elastic conduction element arranged between the keycap and the bottom plate of the key frame, wherein the perforation is covered by the elastic conduction element; and
a connecting member arranged between the keycap and the bottom plate of the key frame, wherein the keycap is movable upwardly or downwardly relative to the bottom plate of the key frame through the connecting member.

2. The keyboard device according to claim 1, wherein the elastic conduction element comprises a covering part and a conduction post, wherein the covering part comprises an accommodation space, and the conduction post is connected with the covering part and disposed within the accommodation space.

3. The keyboard device according to claim 2, wherein the covering part of the elastic conduction element comprises a top wall, a ring-shaped lower part and a lateral wall, wherein the top wall is connected with the keycap, the lateral wall is extended downwardly from a periphery region of the top wall and connected with the ring-shaped lower part, the ring-shaped lower part is contacted with the bottom plate of the key frame, the accommodation space is defined by the top wall and the lateral wall, and the conduction post is connected with the top wall.

4. The keyboard device according to claim 3, wherein while the keycap is moved downwardly relative to the bottom plate of the key frame through the connecting member, the covering part of the elastic conduction element is compressed by the keycap, the lateral wall is subjected to deformation, and the top wall is correspondingly moved downwardly, wherein while the top wall is moved downwardly, the conduction post is moved downwardly in a direction toward the membrane circuit board, wherein while the conduction post is moved downwardly, the conduction post is penetrated through the perforation of the bottom plate and contacted with a membrane switch of the membrane circuit board.

5. The keyboard device according to claim 3, wherein the bottom plate of the key frame further comprises a fixing recess, wherein the fixing recess is arranged around the perforation, and the ring-shaped lower part of the elastic conduction element is embedded in the fixing recess of the bottom plate.

6. The keyboard device according to claim 1, wherein the bottom plate of the key frame further comprises plural hollow portions, and the perforation is arranged between the plural hollow portions.

7. The keyboard device according to claim 1, wherein the bottom plate of the key frame has a top surface and a bottom surface, which are opposed to each other, wherein the connecting member is installed on the top surface of the bottom plate, and the membrane circuit board is installed on the bottom surface of the bottom plate.

8. The keyboard device according to claim 1, wherein the connecting member is a scissors-type connecting member.

9. The keyboard device according to claim 1, wherein the key frame is made of plastic material.

10. A key structure, comprising:
a keycap;
a membrane circuit board located under the keycap;
a key frame arranged between the keycap and the membrane circuit board, wherein the key frame comprises a frame body and a bottom plate, the bottom plate is arranged between the frame body and the membrane circuit board, and the bottom plate comprises a perforation;
an elastic conduction element arranged between the keycap and the bottom plate of the key frame, wherein the perforation is covered by the elastic conduction element; and
a connecting member arranged between the keycap and the bottom plate of the key frame, wherein the keycap is movable upwardly or downwardly relative to the bottom plate of the key frame through the connecting member.
